(19) United States
(12) Patent Application Publication
(10) Pub. No.: US 2026/0222497 A1
(43) Pub. Date: Jul. 30, 2026

(54) MANAGEMENT SYSTEM AND INFORMATION MANAGEMENT METHOD

(71) Applicant: CANON KABUSHIKI KAISHA, Tokyo (JP)

(72) Inventor: TAKAHIRO KOSEKI, Kanagawa (JP)

(21) Appl. No.: 19/442,091

(22) Filed: Jan. 7, 2026

(30) Foreign Application Priority Data
Jan. 28, 2025 (JP) 2025-012057

(51) Int. Cl. H04N 1/00

(52) U.S. Cl. CPC H04N 1/00037

(57) ABSTRACT

An object device transmits operation information including error information in the object device and information indicating an operation status of components of the object device to a management device. The management device acquires the operation information including error information in the object device and information indicating the operation status of components of the object device from the object device, manages the operation information, and provides the operation information to a display device. An information terminal displays the error information and the information indicating the operation status on the basis of the operation information provided from the management device.

### BACKGROUND

### Field

The present disclosure relates to a management system and an information management method for remotely referring to an operation status of a device.

### Description of the Related Art

In the related art, a monitoring service that can monitor an operation status of an image forming apparatus such as a printer (hereinafter referred to as a device) and monitor an occurrence status of an error is known. Japanese Unexamined Patent Publication No. 2024-106415 discloses a system that monitors an operation status of a device and proposes measures against an error when an error has occurred.

On the other hand, some devices may have a means for measuring and displaying information such as degrees of contamination of components using a sensor attached to the devices. A serviceman who maintains the devices moves to a place at which a device is installed and ascertains such information using a user interface (UI) of the device. The ascertained information is used as one piece of information at the time of maintenance of the device.

The information such as degrees of contamination of components of a device is preferably ascertained before a serviceman is dispatched. However, in Japanese

Unexamined Patent Publication No. 2024-106415, measures against errors are presented, and thus a serviceman cannot ascertain what component or tool the serviceman is to prepare unless an error occurs.

### SUMMARY

The present disclosure provides a technique for allowing a user such as a serviceman to refer to information of a device regardless of whether an error has occurred.

In order to solve the aforementioned problems, a management system according to the present disclosure includes an object device and a management device that manages an operation status of the object device. The object device includes: a memory storing instructions; and a processor executing the stored instructions causing the object device to transmit operation information including error information in the object device and information indicating an operation status of components of the object device to the management device. The management device includes: one or more memories storing instructions; and one or more processors executing the stored instructions causing the management device to acquire the operation information including error information in the object device and information indicating the operation status of components of the object device from the object device, manage the operation information, and provide the operation information stored in the management device to a display device. The error information and the information indicating the operation status are displayed on the display device on the basis of the provided operation information.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating the entire configuration of a system according to a first embodiment.

FIGS. 2A and 2B are the diagrams illustrating an example of a hardware configuration of a device management server and an image forming apparatus illustrated in FIG. 1.

FIG. 3 is a diagram illustrating an example of a software configuration of a system illustrated in FIG. 1.

FIG. 4A is a diagram illustrating an example of an error information check screen that is provided by the device management server.

FIG. 4B is a diagram illustrating an example of an error information check screen that is provided by the device management server.

FIG. 4C is a diagram illustrating an example of an error information check screen that is provided by the device management server.

FIG. 5A is a flowchart illustrating a sensor operation status analyzing process that is performed by an image forming apparatus.

FIG. 5B is a flowchart illustrating a process flow of transmitting an operation status received from an image forming apparatus to a browser that is performed by the device management server.

FIG. 5C is a flowchart illustrating a process flow of updating a screen display on the basis of an operation status received from the device management server by a browser.

FIG. 6 is a diagram illustrating an example of an operation status check screen that is provided by the device management server.

FIG. 7 is a diagram illustrating an example of a software configuration of a system according to a second embodiment.

FIG. 8 is a diagram illustrating an example of an operation status check screen in the system illustrated in FIG. 7.

FIG. 9 is a flowchart illustrating an error screen generating process that is performed by a device management server according to a third embodiment.

FIG. 10 is a diagram illustrating an example of an error display screen that is displayed by a browser according to the third embodiment.

FIG. 11 is a flowchart illustrating a process flow of synchronizing notifications of a device management server and an image forming apparatus according to a fourth embodiment.

### DESCRIPTION OF THE EMBODIMENTS

### First Embodiment

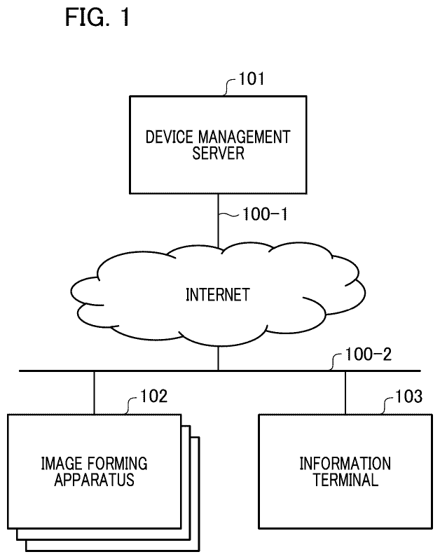

Hereinafter, an embodiment of the present disclosure will be described with reference to the accompanying drawings. FIG. 1 is a diagram illustrating a configuration of a device management system according to the present embodiment. The device management system includes a device management server 101, an image forming apparatus 102, and an information terminal 103. The device management system including the device management server 101 is a management system that can check an operation status of each device that is managed as a managed device by the device management server 101 and allows a display device of the information terminal 103 or the like to refer to the operation status as a degree of consumption or the like.

The device management server 101 is connected to the Internet via a network 100-1. The image forming apparatus 102 and the information terminal 103 are connected to the Internet via a network 100-2. Accordingly, the image forming apparatus 102 can communicate with the device management server 101 via the Internet, and the information terminal 103 can communicate with the device management server 101 via the Internet. The networks 100-1 and 100-2 may be parts of the Internet. The networks 100-1 and 100-2 and the Internet are so-called communication networks which are realized by a LAN, a WAN, a telephone line, or the like as long as they can transmit and receive data.

The device management server 101 receives operation information including error information indicating an error occurring in the image forming apparatus 102 or an operation status thereof. For example, when error information is received, the device management server 101 estimates information of one or more repair components for resolving the error. The device management server 101 manages results of component exchange carried out in the market on the same error in the past as market performances and determines priorities of repair components to be repaired on the basis of the market performances. The device management server 101 generates a repair sequence screen for resolving the error in response to a request from the information terminal 103.

The device management server 101 generates a screen indicating an operation status other than error information in response to a request from the information terminal 103 and transmits the screen. Details thereof will be described later.

The image forming apparatus 102 is a device of which an operation status is to be monitored in the present embodiment and instructs the device management server 101 to notify the information terminal 103 registered in the device management server 101 when an operation status or an error occurs. The image forming apparatus 102 is configured, for example, as a printer. The image forming apparatus 102 includes a copy machine or a multifunction machine in addition to a printer. For example, the multifunction machine has a plurality of functions such as a printing function, a scanning function, a copying function, and a transmission function.

The information terminal 103 is an information terminal that is connected to the device management server 101 via a network and displays information managed by the device management server 101. The information terminal 103 is, for example, a smartphone which is generally known and may be a personal computer or a tablet as long as it can display a screen using a browser or the like.

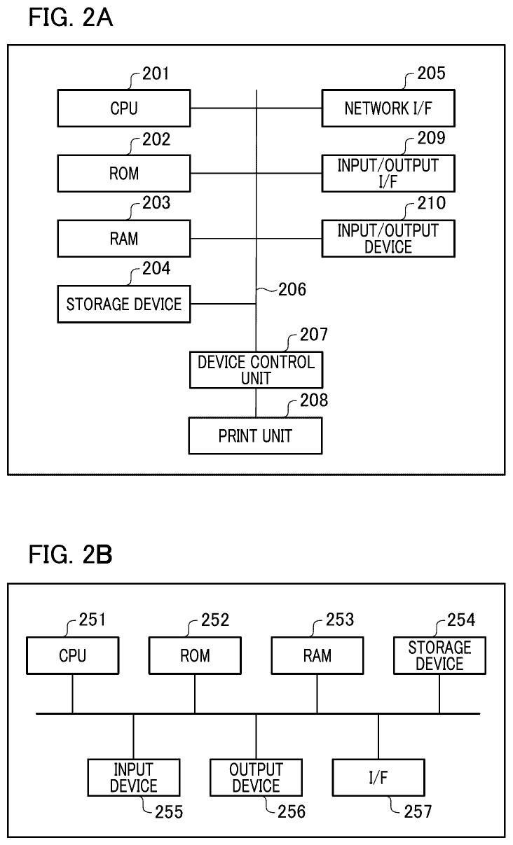

FIG. 2 (A) is a diagram illustrating a hardware configuration of the image forming apparatus 102 according to the present embodiment. The image forming apparatus 102 includes a CPU 201, a ROM 202, a RAM 203, a storage device 204, a network I/F 205, an internal bus 206, a device control unit 207, a print unit 208, an input/output I/F 209, and an input/output device 210.

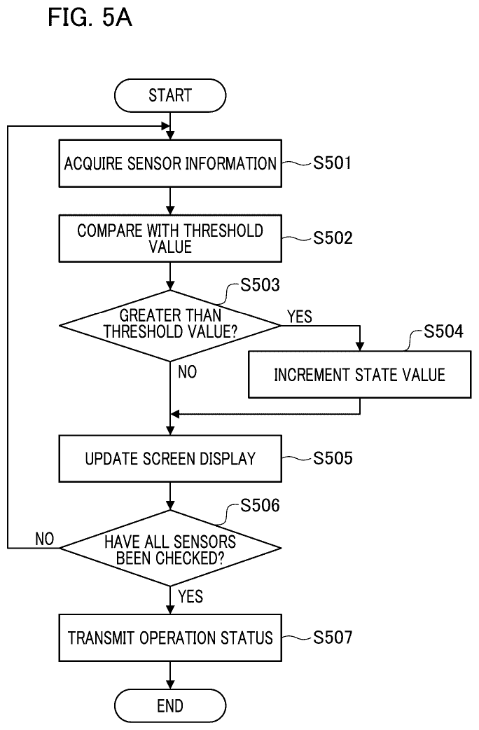

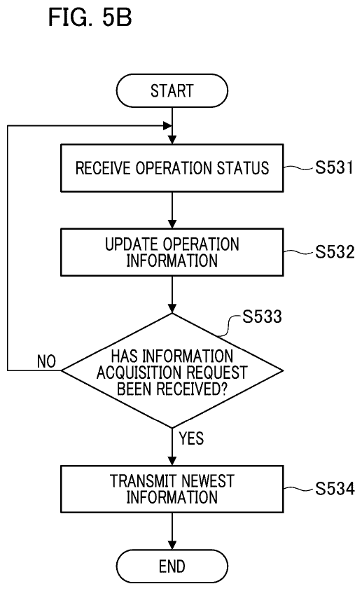

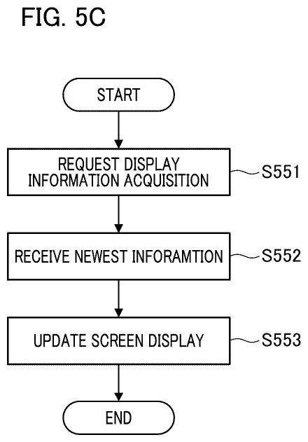

The CPU 201 includes programs (which include a program for realizing a process flow in FIG. 5A or the like which will be described later) stored in the ROM 202 and comprehensively controls the blocks via the internal bus 206. The CPU 201 performs a process of executing a program in cooperation with the ROM 202 or the RAM 203 and performs a process of recording image data on a recording medium such as the storage device 204.

The ROM 202 stores programs, data used in the programs, and the like as described above. The RAM 203 serves as a memory or a work area of the CPU 201 and stores information of events occurring in the image forming apparatus 102, various types of counter information, consumption degree information of consumable components, various logs, and the like. The storage device 204 serves as an external storage device and stores image data or the like. Instead of the RAM 203, the storage device 204 can store the event information, the various types of counter information, the consumption degree information of consumable components, and various logs.

The network I/F 205 can exchange data with the information terminal 103 or the device management server 101 outside of the image forming apparatus 102 via a network in one direction or both directions. The device control unit 207 controls the print unit 208 in response to a print request or the like. The input/output device 210 receives an input (scanning, a button input, or the like) from a user of the image forming apparatus 102 and outputs control data, commands, or the like to the aforementioned blocks using the input/output I/F 209.

FIG. 2 (B) is a diagram illustrating a hardware configuration of the device management server 101 and the information terminal 103 according to the present embodiment. The device management server 101 and the information terminal 103 include a CPU 251, a ROM 252, a RAM 253, a storage device 254, an input device 255, an output device 256, and a network I/F 257.

The CPU 251 directly or indirectly controls blocks connected thereto via an internal bus and executes a program such as a software module which will be described later. The CPU 251 often loads various software modules which will be described later from the storage device 254 to the RAM 253 to be executable with operation of an OS which is basic software. Various software modules are executed to operate by the CPU 251 in cooperation with the blocks.

The ROM 252 stores, for example, a BIOS. The RAM 253 is used as a work area of the CPU 251 or is used as a primary memory to which various software modules are loaded. The storage device 254 stores the OS or the software modules. The storage device 254 is constituted, for example, by an HDD or an SSD.

The input device 255 is constituted, for example, by a keyboard or a pointing device. The output device 256 is constituted, for example, by a display. The network I/F 257 is an interface (I/F) for connection to the network 100-2. The network I/F 257 is connected to the Internet via the network 100-2 and is controlled by the CPU 251 with operation of the OS such that communication is realized.

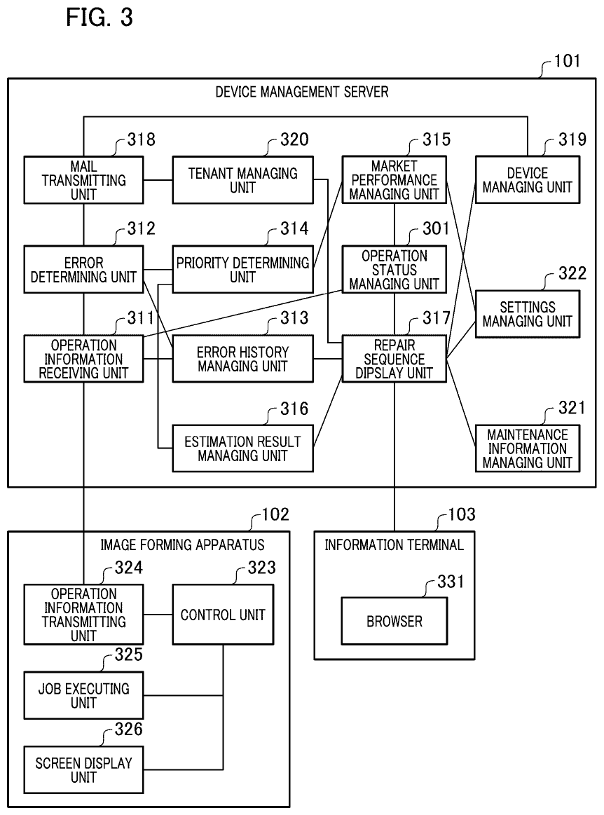

FIG. 3 is a diagram illustrating software configurations of the devices such as the device management server 101, the image forming apparatus 102, and the information terminal 103 according to the present embodiment. Specifically, the software configurations are realized by causing the CPU 201 or the CPU 251 to execute software (programs) stored in the memories of the devices. The configuration of the device management server 101 will be first described.

An operation information receiving unit 311 receives operation information along with identification information of an image forming apparatus 102 from the image forming apparatus 102. The operation information received by the operation information receiving unit 311 includes error information indicating an error or log information of the image forming apparatus 102. The operation information also includes counter information of a component counter indicating a total number of printed sheets of printing performed by the image forming apparatus 102 or a degree of consumption of each component or the like. The operation information also includes sensor information analyzed or the like by the image forming apparatus 102 or analysis results. Hereinafter, information other than the error information in the operation information is referred to as an operation status (information indicating the operation status).

In the image forming apparatus 102, an inference algorithm for calculating component conditions prepared for components to be analyzed is mounted, and an analysis module (not illustrated) for performing an analysis process using the inference algorithm is mounted. Counter information, sensor values, and the like are input to the inference algorithm. Analysis results from the analysis module specifically indicate state values identified on the basis of sensor information (an analysis value calculated from a degree of contamination or a counter value of a target component of each sensor). The information indicating an operation status is also particularly referred to as condition information. The condition information includes, for example, a state value for predicting occurrence of drum damage. This state value is identified through inference or analysis using sensing data including a drum film thickness detection current result, a rotation speed and a rotation time of a drum, and a process speed of an engine in addition to identification of a color of a drum. Accordingly, it is possible to detect a likelihood of random failure such as occurrence of drum damage. In addition, the condition information includes a state value for predicting a defect place of a document reader. This state value is identified through inference or analysis using sensing data such as a reader shading value of a reading surface or for each color of black and RGB or a CMOS sensor temperature. Accordingly, it is possible to detect a likelihood of contamination of a reader and thus to enable countermeasures such as resolving an abnormality by performing cleaning instead of performing exchange.

This condition information is a value which is calculated at a timing considering a power state, a job execution state, and the like in the image forming apparatus 102 and is implemented mainly for display and use on a display of the image forming apparatus 102 at the time of repair of the image forming apparatus 102.

In the following embodiments, the condition information displayed on the display of the image forming apparatus 102 is transmitted as a part of the information indicating an operation status to the device management server 101.

That is, the operation information receiving unit 311 serves as an operation information acquiring means for acquiring operation information including error information of an error occurring in an object device and information indicating the operation status of components of the object device from the object device (the image forming apparatus 102).

When the error information is received from the operation information receiving unit 311, an error determining unit 312 acquires an error history which is information on errors having occurred in the past in the image forming apparatus 102 in which the error has occurred from an error history managing unit 313. The error determining unit 312 identifies one or more repair components for resolving the error with the received error information and transmits repair component information along with the error information as a determination result to a priority determining unit 314 which will be described later.

At this time, when the error determining unit 312 cannot identify a repair component for a certain reason, for example, because an error of a certain error code cannot be identified, the error determining unit 312 transmits a determination result of “no repair component is identified” along with the error information to the priority determining unit 314 which will be described later.

The error determining unit 312 stores the error information received from the image forming apparatus 102 as an error history in the error history managing unit 313. The error determining unit 312 transmits error information including a device ID for identifying a device and an error code to a mail transmitting unit 318 which will be described later to transmit an URL for allowing a user such as a serviceman to access a repair sequence screen.

The error history managing unit 313 stores and manages the error information received from the image forming apparatus 102 as an error history. An example of a part of an error history managed by the error history managing unit 313 is shown in Table 1. The error history includes an error ID for uniquely identifying an error, a device ID for uniquely identifying an image forming apparatus in which an error has occurred, a model number indicating a model, an error code which is a type of an error having occurred, a counter value which is the number of printed sheets at the time of occurrence of an error, and an error occurrence date and time.

TABLE 1

| | | Model | | Counter | Occurrence date and |
|---|---|---|---|---|---|
| Error ID | Device ID | number | Error code | value | time |
| Err-001 | DEV00001 | Model-001 | E001-0001 | 5000 | 2024-10-16T14:52:31Z |
| Err-002 | DEV00002 | Model-002 | E001-0002 | 1500 | 2024-10-13T09:24:20Z |
| Err-003 | DEV00003 | Model-003 | E001-0003 | 2000 | 2024-10-10T21:35:55Z |

When a determination result is received from the error determining unit 312, the priority determining unit 314 acquires information of market performances of which a model number and an error code match those of error information included in the determination result out of market performances stored and managed in a market performance managing unit 315. The priority determining unit 314 prioritizes the market performances of which a repair component and a component number match those included in the determination result as “repair components with high likelihoods that an error will be resolved” in the descending order of the number of component exchanges and stores the prioritized repair sequence as an estimation result in an estimation result managing unit 316.

The market performance managing unit 315 manages details of measures taken by a serviceman to resolve errors having occurred in the past and collected and recorded in correlation with model numbers, error codes, and component numbers of image forming apparatuses as results. An example of market performances managed in the market performance managing unit 315 in association with component exchange performed by a serviceman is shown in Table 2. The market performances include a model number indicating a model, an error code which is a type of an error having occurred, a component number indicating a component exchanged in association with an error, and the number of exchanges which is the number of results of component exchange.

TABLE 2

| | | | Number of |
|---|---|---|---|
| Model number | Error code | Component number | exchanges |
| Model-001 | E001-0001 | Part1-111 | 482 |
| Model-001 | E001-0001 | Part2-222 | 317 |
| Model-002 | E002-0002 | Part3-333 | 659 |
| Model-002 | E002-0002 | Part4-444 | 204 |
| Model-002 | E003-0003 | Part5-555 | 731 |

The estimation result managing unit 316 stores and manages the estimation results which are a prioritized repair sequence prepared by the priority determining unit 314. An example of a part of the estimation result managed in the estimation result managing unit 316 is shown in Table 3. The estimation result includes a device ID, an error ID, a component number of a repair component in association with an error and a priority indicating the priority of a component to be repaired.

TABLE 3

| Device ID | Error ID | Component number | Priority |
|---|---|---|---|
| DEV00001 | Err-001 | Part1-111 | 23.4 |
| DEV00001 | Err-001 | Part2-222 | 45.1 |
| DEV00002 | Err-001 | Part3-333 | 68.3 |
| DEV00002 | Err-002 | Part4-444 | 76.8 |
| DEV00002 | Err-002 | Part5-555 | 90.4 |

In the present embodiment, it is assumed that a larger numerical value of a priority has a higher repair priority. As a method of calculating a priority, for example, a method described in Japanese Unexamined Patent Publication No. 2024-106415 may be used. That is, the priority is calculated, for example, as a ratio of the number of exchanges of repair components to the total number of exchanges of all repair components to be repaired, and the method of calculating the priority is not limited to the aforementioned method and may employ any method.

A repair sequence display unit 317 provides data such as HTML for a screen to be displayed by the browser 331 in response to reception of a repair sequence acquisition request including a device ID and an error ID from the browser 331 of the information terminal 103 which will be described later. The repair sequence display unit 317 acquires an error history of which a device ID and an error ID match those requested by the error history managing unit 313 at the time of provision of data. The repair sequence display unit 317 acquires an estimation result of which a device ID and an error ID match from the estimation result managing unit 316. The repair sequence display unit 317 acquires a tenant ID and a model number of which a device ID matches from a device managing unit 319 which will be described later and acquires maintenance information of which a model number and an error ID match from a maintenance information managing unit 321 which will be described later. The repair sequence display unit 317 acquires maintenance information display settings of which the acquired tenant ID and an maintenance information ID match from a settings managing unit 322 and determines whether the maintenance information to be included in a repair sequence screen according to details of the maintenance information display settings.

When error information including a device ID for identifying a device and an error code is received from the error determining unit 312, the mail transmitting unit 318 generates a direct URL for directly accessing the repair sequence screen for resolving the received error. Then, the mail transmitting unit 318 acquires a tenant ID of device information of which a device ID matches from the device managing unit 319 which will be described later. In addition, the mail transmitting unit 318 acquires a mail address of tenant information of which the acquired tenant ID matches from a tenant managing unit 320 which will be described later and transmits a mail including the generated direct URL.

The device managing unit 319 manages and stores device information of the image forming apparatus 102 managed in the device management server 101. An example of a part of device information managed in the device managing unit 319 is shown in Table 4. The device information includes a device ID for uniquely identifying a device, a tenant ID indicating an organization to which a device belongs, and a model number indicating a model.

TABLE 4

| Device ID | Tenant ID | Model number |
|---|---|---|
| DEV00001 | TENANT_A | Model-001 |
| DEV00002 | TENANT_B | Model-001 |
| DEV00003 | TENANT_B | Model-002 |

The tenant managing unit 320 stores and manages tenant information indicating an organization to which a device belongs. An example of a part of tenant information managed in the tenant managing unit 320 is shown in Table 5. The tenant information includes a tenant ID for uniquely identifying a tenant, a parent tenant ID which is an upper tenant of the tenant, a region in which a tenant is present, and a mail address which is a mail destination when an error occurs in a device belonging to a tenant. A mail address receivable by an operator taking charge of maintenance of a device is registered as the mail address. In the case of an uppermost tenant, since there is no parent tenant, the parent tenant ID includes no value or includes a fixed character string indicating that there is no value such as “-”

TABLE 5

| Tenant ID | Parent tenant ID | Region | Mail address |
|---|---|---|---|
| TENANT_A | — | JP | user-a@example.com |
| TENANT_B | TENANT_A | JP | user-b@example.com |
| TENANT_C | — | US | user-c@example.com |
| TENANT_D | TENANT_C | US | user-d@example.com |
| TENANT_E | TENANT_C | US | user-e@example.com |

A tenant indicating an organization has a hierarchy structure and can own one or more subordinate tenants. A tenant has a tree structure of tenants which is independent for each region, and the tenant allows a subordinate tenant to perform operations of publication setting and display setting of maintenance information which will be described later. Accordingly, it is possible to control whether an upper tenant allows a lower tenant to display maintenance information.

The maintenance information managing unit 321 manages maintenance information for predetermined identification information of a device or an error issued at that time. An example of a part of maintenance information managed in the maintenance information managing unit 321 is shown in Table 6. The maintenance information includes a maintenance information ID for uniquely identifying maintenance information, a region indicating a publication service area, a model number which is a target model of maintenance information, an error code which is a target error code, a title indicating details of maintenance information, and a maintenance information URL indicating a place of contents of maintenance information.

TABLE 6

| Maintenance | | | | | |
|---|---|---|---|---|---|
| information | | Model | | | Maintenance |
| ID | Region | number | Error code | Title | information URL |
| SI035-0220- | JP, US | Model-001 | — | Defect of OO | https://www.sample/001 |
| 10 | | | | | |
| SI040-0330- | JP, US | Model-001 | E001-0001 | Error E001-0001 | https://www.sample/002 |
| 20 | | | | | |
| SI050-0110- | JP | Model-002 | — | Firmware update | https://www.sample/003 |
| 30 | | | | | |

In maintenance information not associated with an error, information of an error code column is managed in none (a fixed character string such as “-”). The maintenance information may be managed using a device number (a serial number) or the like.

The settings managing unit 322 manages setting information for determining whether to display maintenance information for each tenant on the repair sequence screen. An example of a part of setting information managed in the settings managing unit 322 is shown in Table 7. The setting information includes a tenant ID which is a tenant to be set, a maintenance information ID which is maintenance information of a setting target, publication setting indicating whether to publish maintenance information to a target tenant, and display setting indicating to display maintenance information on the repair sequence screen.

TABLE 7

| | Maintenance | | |
|---|---|---|---|
| Tenant ID | information ID | Publication setting | Display setting |
| TENANT_A | SI035-0220-10 | Published | Displayed |
| TENANT_A | SI040-0330-20 | Published | Non-displayed |
| TENANT_A | SI050-0110-00 | Non-published | Non-displayed |
| TENANT_C | SI065-0440-40 | Non-published | Displayed |
| TENANT_C | SI080-0880-80 | Non-published | Displayed |
| TENANT_C | SI015-0990-90 | Published | Non-displayed |

The publication information is settings capable of being set in a subordinate tenant by an upper tenant based on the tenant information, and maintenance information of which the publication setting is “non-published” is not displayed on the repair sequence screen. The display setting is an item for determining whether to display maintenance information of which the publication setting is “published.” That is, only maintenance information of which the publication setting is “published” and the display setting is “displayed” is displayed on the repair sequence screen. For example, in Table 7, the maintenance information ID of maintenance information which can be displayed on the repair sequence screen when an error has occurred in a device in a tenant “TENANT A” is “SI035-0220-10.”

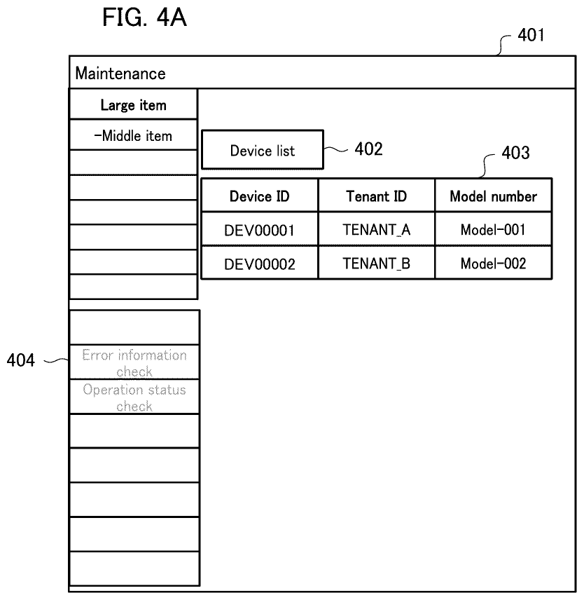

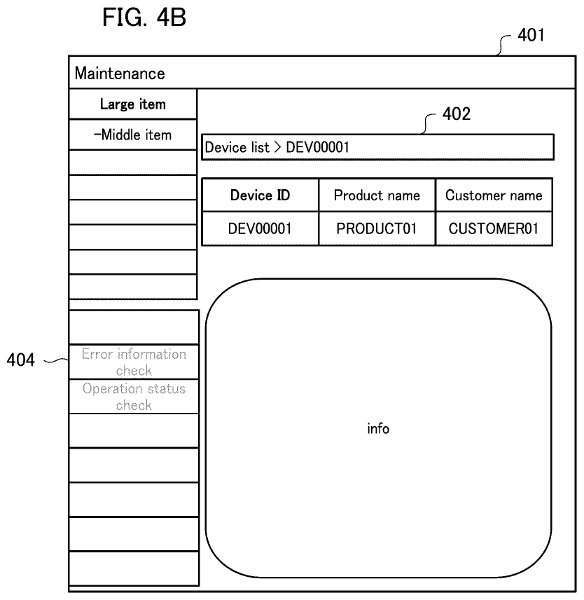

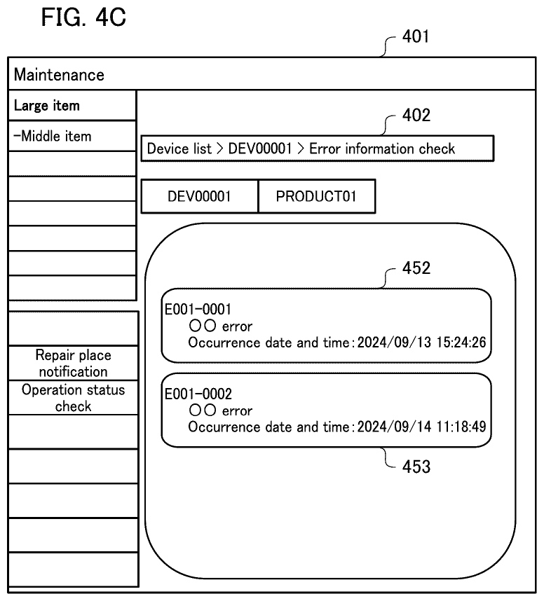

Display examples of an error notification screen according to the present embodiment are illustrated in FIGS. 4A to 4C. Information shown in Tables 1 to 7 is used to display the screen. FIG. 4A illustrates an example of an operation status check screen which is displayed by a browser 331 of the information terminal 103 which will be described later.

A device management screen 401 is a screen that can be displayed by the browser 331 and displays error information or an operation status of a device designated by a user. Reference sign 402 denotes a breadcrumb trail indicating a current page layer. FIG. 4A illustrates a screen for selecting a device of which operation information (error information or an operation status) is to be checked. Reference sign 403 denotes a device list of which operation information is to be checked and is displayed by acquiring device information managed in the device managing unit 319. In the device list 403, a device ID, a tenant ID, and a model number are displayed, the device ID and the model number are acquired from the acquired device information, and the tenant ID is displayed by acquiring a customer ID from the tenant managing unit 320 on the basis of the acquired device ID. A sub menu 404 is displayed in a deactivated state because no device is selected in the breadcrumb trail 402. When a device is selected in the device list 403, the sub menu 404 is changed to an activated state.

FIG. 4B illustrates a display example of the screen after a device has been selected in FIG. 4A. In FIG. 4B, for example, it is assumed that DEV00001 is selected. The breadcrumb trail 402 indicates a current page layer and indicates that the hierarchy goes down to a deeper layer by selecting a device in the state illustrated in FIG. 4A. When a device is selected and the hierarchy becomes deeper, the sub menu 404 changes to the activated state, and a user can check error information or an operation status of the selected device.

FIG. 4C illustrates a display example of a screen for displaying error information with a device name: DEV00001 after the sub menu 404 has been selected in FIG. 4B. The breadcrumb trail 402 indicates a current page layer and indicates that the hierarchy goes down to a deeper layer by selecting “error information check” (the sub menu also changes to “repair place notification”). Reference signs 452 and 453 denote display examples of error information, and an error code, error details, and an occurrence date and time are displayed. The error information is displayed on the basis of information received from the error history managing unit 313, the repair sequence display unit 317, the maintenance information managing unit 321, or the like.

Referring back to FIG. 3, an operation status managing unit 301 manages operation statuses including a degree of deterioration or a degree of consumption such as degrees of contamination of components in the image forming apparatus 102. An example of information managed in the operation status managing unit 301 is shown in Table 8. Table 8 is a table showing operation statuses managed in the operation status managing unit 301 and includes a device ID, an occurrence place, a state value, a state category, and an update date and time. That is, the operation status managing unit 301 serves as a history managing means for storing and managing operation statuses received from the image forming apparatus 102.

TABLE 8

| Device | Occurrence | State | State | |
|---|---|---|---|---|
| ID | place | value | category | Update date and time |
| DEV00001 | UNIT-A | 3 | Cleaning | 2024-10-15T21:55:51Z |
| DEV00001 | UNIT-A | 2 | Adjust- | 2024-10-13T08:16:13Z |
| | | | ment | |
| DEV00002 | UNIT-A | 3 | Cleaning | 2024-10-10T21:35:55Z |

The device ID is a value for uniquely identifying the image forming apparatus 102. The occurrence place indicates component information in which an operation status has changed in the image forming apparatus 102. The state value is a state value indicating an operation status such as a degree of contamination of the corresponding component. The state category indicates a category of measures which a user such as a serviceman is to take for the operation status. The update date and time is set to a date and time at which the operation status of the component has been received from the image forming apparatus 102 and the value has been updated.

The operation status managing unit 301 also manages error information. An example of the error information managed by the operation status managing unit 301 is show in Table 9. Table 9 is a table showing error information managed by the operation status managing unit 301 and includes a device ID, an error code, a component number, and an occurrence date and time. The device ID indicates the image forming apparatus 102 in which an error has occurred. The error code indicates an error having occurred in the object device. The component number indicates a number for uniquely identifying a component serving as a cause of the error occurrence place. The occurrence date and time is set to a date and time at which the error of the component has occurred.

TABLE 9

| Device ID | Error code | Component number | Update date and time |
|---|---|---|---|
| DEV00001 | E001-001 | Part1-111 | 2024-10-16T14:52:31Z |
| DEV00001 | E002-002 | Part2-222 | 2024-10-13T09:24:20Z |
| DEV00002 | E003-003 | Part3-333 | 2024-10-10T21:35:55Z |

The configuration of the image forming apparatus 102 will be described below. The image forming apparatus 102 includes a control unit 323, an operation information transmitting unit 324, a job executing unit 325, and a screen display unit 326. The control unit 323 detects an error occurring in the image forming apparatus 102, collects error information, and transmits the error information to the device management server 101 via the operation information transmitting unit 324. The control unit 323 acquires sensor information from consumable components such as toner or ink or a sensor attached to the job executing unit 325 and analyzes the sensor information. An analysis result is transmitted along with the operation status from the operation information transmitting unit 324 which will be described later.

The operation information transmitting unit 324 transmits the information of an error having occurred in the image forming apparatus 102, an operation status, and the like collected by the control unit 323 as operation information to the device management server 101. That is, the operation information transmitting unit 324 serves as a transmission means for transmitting operation information including error information in an object device and information indicating an operation status of components of the object device to the management device.

The job executing unit 325 executes a job input to the image forming apparatus 102. For example, when a print job is input, the job executing unit 325 performs a printing process on the basis of the print job.

The screen display unit 326 displays an analysis result for the sensor information analyzed by the control unit 323 or the like on a screen.

The configuration of the information terminal 103 will be described below. A browser 331 is installed in the information terminal 103. The information terminal 103 transmits an acquisition request for screen information or the like to the device management server 101 via the browser 331, receives screen information from the device management server 101, and displays a graphical user interface (GUI).

FIG. 5A is a flowchart illustrating a process flow of sensor operation status analysis that is performed by the image forming apparatus 102. It is assumed that the flowchart illustrated in FIG. 5A is performed periodically using an internal timer or the like mainly by the control unit 323. A trigger is not limited to the timer, and an instruction from a user via the screen display unit 326 may be used as a trigger. The flowchart illustrated in FIG. 5A may operate normally. In FIGS. 5A to 5C, a word Step is omitted by prefixing S to the steps.

The processes of S501 to S507 are performed in the image forming apparatus 102. S501 is a process of causing the control unit 323 to acquire sensor information of one of a plurality of sensors provided in the image forming apparatus 102. The sensor information acquired in S501 includes, for example, contamination information using an optical sensor. The sensor information may include counter information indicating a degree of consumption. That is, this information is a value detected by a sensor provided in a component of an object device.

S502 is a process of comparing the sensor information acquired in S501 with a predefined threshold value. For example, a degree of contamination estimated at the time of component design or the counter value shown in Table 1 is compared with the acquired sensor information.

S503 is a process of determining whether the sensor information used for comparison is greater than the threshold value. When the sensor information is greater than the threshold value, a state value is increased in S504. The state value is a value calculated as a ratio of the current sensor information to the degree of contamination or the counter value. That is, the state value is the aforementioned analysis result. For example, by stepwise setting the threshold value for the sensor information associated with the degree of contamination to 90% or 70%, the state value can serve as a criterion for showing the degree of contamination of the corresponding component with check of the state value. It is assumed that the proportions of the threshold value can be arbitrarily set by a service provider.

S505 is a process of updating information displayed on the screen display unit 326.

S506 is a process of determining whether all pieces of sensor information in the image forming apparatus 102 have been acquired. When all pieces of sensor information have not been acquired, the process flow returns to S501, and the processes of S501 to S505 are repeated. When all pieces of sensor information have been checked, the checked sensor information or the analysis result (the operation status) is transmitted to the device management server 101 in S507.

FIG. 5B is a flowchart illustrating a process flow of transmitting an operation status received from the image forming apparatus 102 to the browser 331 that is performed in the device management server 101.

S531 is a process of causing the operation information receiving unit 311 to receive the operation status transmitted from the image forming apparatus 102 in S507. In the device management server 101, since information such as a counter value or a state value is included in the operation status received in S532 and the same information is stored in the operation status managing unit 301, the information stored in the operation status managing unit 301 is updated in S532. In S533, it is determined whether an operation status acquisition request has been received from the browser 331. When the operation status acquisition request has been received, the operation status (newest information) stored in the operation status managing unit 301 is transmitted to the browser 331 via the repair sequence display unit 317 in S534. That is, the repair sequence display unit 317 serves as a provision means for providing operation information stored in the history managing means to a display device.

FIG. 5C is a flowchart illustrating a process flow of updating screen display on the basis of the operation status received from the device management server 101 by the browser 331. In S551, an acquisition request for acquiring a current operation status is transmitted to the device management server 101. In S552, the newest operation status transmitted from the device management server 101 in S534 is received. Then, the screen display is updated to display the newest operation status received in S553. That is, the browser 331 displays the provided operation information.

As can be clearly seen from the aforementioned description, FIGS. 5A and 5B are flowcharts serving as an information management method, and the flowchart illustrated in FIG. 5A serves as a transmission step and the flowchart illustrated in FIG. 5B serves as an operation information acquiring step and a provision step. The error information and the information indicating an operation status are displayed on the basis of the operation information provided in the flowchart illustrated in FIG. 5C.

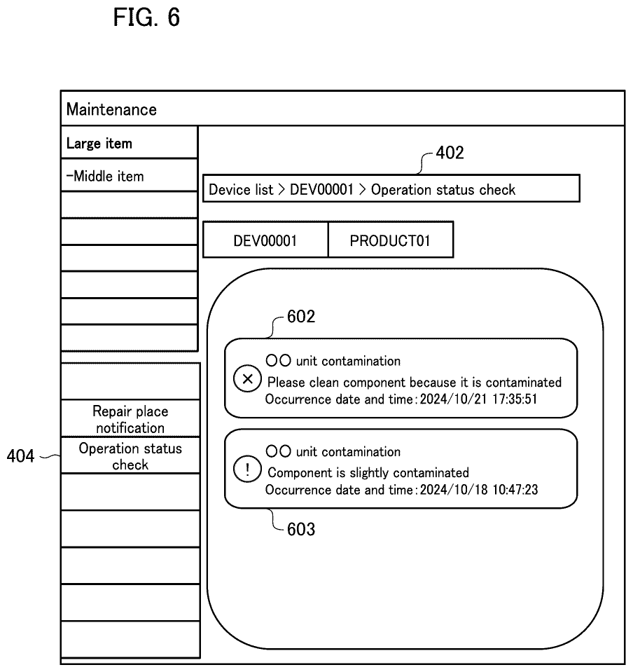

FIG. 6 illustrates a display example of a screen for displaying an operation status of a device with a device name: DEV00001 after the sub menu 404 has been selected. The breadcrumb trail 402 indicates a current page layer and indicates that the hierarchy goes down to a deeper layer by selecting “operation information check” in the sub menu 404 in FIG. 4B. Reference signs 602 and 603 are display examples of an operation status of a OO unit and indicate that marks “X” and “!” change according to a state value of contamination. That is, the marks such as “X” and “!” are information indicating the operation status and are marks based on a value detected by a sensor. As the state value of contamination or the like, the state value updated in S504 to S506 in FIG. 5A is received in S552 of FIG. 5C through the process flow illustrated in FIG. 5B and is displayed in S553.

The state indicated by the operation status can be arbitrarily set by a system manager and is calculated as a ratio of a current degree of contamination to a limit of the degree of contamination of the corresponding component. The counter value shown in Table 1 or the like is referred to for the degree of contamination of the corresponding component. In the illustrated example, rapid cleaning is necessary, and the mark “X” is displayed when cleaning is not performed (Reference sign 602). When the contamination of the corresponding component becomes more serious in spite of hindering use of the component, the mark “!” is displayed (Reference sign 603).

That is, the information terminal 103 displays the error information (FIGS. 4A to 4C) and the information indicating the operation status (FIG. 6) on the basis of the operation information.

According to the present embodiment, a user such as a serviceman or a manager can remotely check an operation status of a device such as a degree of contamination of a component via a screen which is provided by the device management server 101. Accordingly, it is possible to refer to information of the device at an arbitrary timing regardless of whether an error from the device has been notified of.

### Second Embodiment

A second embodiment will be described below. In the first embodiment, the method of remotely checking an operation status of a device by allowing the information terminal 103 to transmit the display information acquisition request (S551) for the operation status acquired by the device management server 101 has been described above. However, in the example illustrated in FIG. 6, even when an operation status of a component has been checked, there is a likelihood that it may not be able to cope with an error based on the operation status due to a low priority of a maintenance operation thereof because the error does not have high emergency. Accordingly, in the present embodiment, an example in which screen display is performed such that the priority of the maintenance operation is raised by notifying of an error which will occur in the future when the operation status of the component displayed on the screen is continuously left will be described. In the following description, the same constituents as in the first embodiment will be referred to by the same reference signs, and thus description thereof will be omitted.

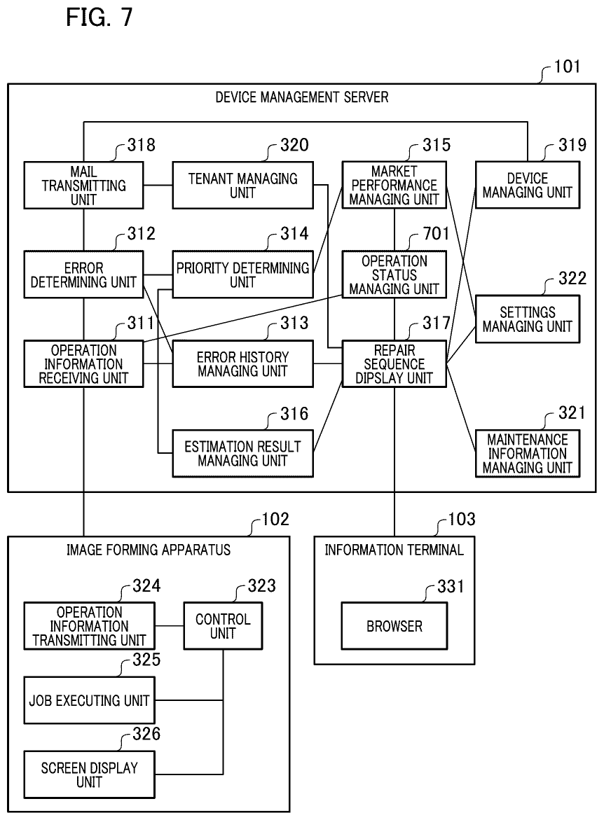

FIG. 7 is a diagram illustrating software configurations of devices according to the present embodiment. FIG. 7 is different from FIG. 3 in that the operation status managing unit 301 is replaced with an operation status managing unit 701. A function of predicting an error which will occur in the future from an operation status is added to the operation status managing unit 701. The operation status managing unit 701 receives an operation status from the operation information receiving unit 311, an error history shown in Table 1 from the error history managing unit 313, and a market performances shown in Table 2 from the market performance managing unit 315 as information required for prediction of an error. The operation status managing unit 701 compares the operation status and the error history, predicts that an error will occur in the future when there is a correlation therebetween, and reflects the prediction result in display on the browser 331 of the information terminal 103. A data modulus for considering that there is a correlation and identifying an operation status in which an error will occur in the future can be arbitrarily determined by a system manager. That is, the operation status managing unit 701 correlates error information with information indicating the operation status.

In the present embodiment, information managed by the operation status managing unit 701 is partially different from that shown in Table 8. An example of the information managed by the operation status managing unit 701 is shown in Table 10.

TABLE 10

| | | | | State value | | |
|---|---|---|---|---|---|---|
| | Occurrence | State | | update date | | Occurrence |
| Device ID | place | category | State value | and time | Error code | date and time |
| DEV0001 | UNIT-A | Cleaning | 3 | 2024-10- | E001-001 | 2024-10- |
| | | | | 15T21:55:51Z | | 15T22:02:31Z |
| DEV0001 | UNIT-A | Cleaning | 2 | 2024-10- | | |
| | | | | 13T08:16:13Z | | |
| DEV0002 | UNIT-A | Adjustment | 3 | 2024-10- | E003-003 | 2024-10- |
| | | | | 10T21:35:55Z | | 10T21:35:55Z |

The operation status in Table 10 includes an actual operation status and error information when the operation status has been left. The actual operation status includes a device ID, an occurrence place, a state category, a state value, and a state value update date and time. The error information includes an error code and an occurrence date and time at which an error has occurred actually. That is, the error information includes a date and time at which an error has occurred, and the information indicating the operation status includes a state value corresponding to an operation status and a date and time of update with the state value. Table 10 is prepared by performing a correlation process with occurrence of an error as a trigger in a case in which an operation status is present.

The correlation process is a process of calculating an occurrence place from information of the error occurrence date and time, the error code, and the component number and considering that there is a correlation when the state value of the operation status at the corresponding place is the highest and the update date and time is close to the error occurrence date and time. For example, in the example illustrated in Table 10, since the state value is “3” which is high and the state value update date and time and the error occurrence date and time are the same or close to each other, it is considered that there is a correlation. A width of an approximate value or a data modulus necessary for consideration of a correlation is arbitrarily determined by a system manager. That is, the operation status managing unit 701 performs the correlation when a time difference between the date and time of update with the state value and the date and time of occurrence of the error is within a predetermined period and the state value is equal to or greater than a predetermined value.

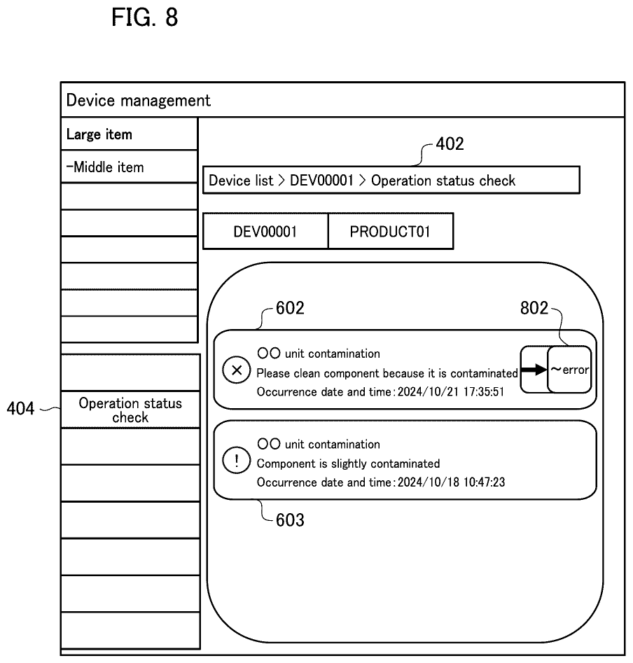

FIG. 8 illustrates a display example of a screen which the device management server 101 according to the present embodiment displays on the information terminal 103 when the display information acquisition request (S551 in FIG. 5C) has been received. In FIG. 8, Reference sign 802 is added to Reference sign 602. Reference sign 802 indicates an example in which an error which will occur in the future when contamination of OO unit has been left is notified of. Reference sign 802 indicates predicted error information obtained as a result of the correlation process performed by the operation status managing unit 701. The predicted error information is information predicted through processing in the device management server 101 and is different from error information transmitted from the image forming apparatus 102.

That is, the operation status managing unit 701 predicts an error which will occur in the future from a predetermined operation status on the basis of the correlation between the error information and the information indicating the operation status. The repair sequence display unit 317 transmits prediction information which is a prediction result along with the operation information, and the information terminal 103 also displays the prediction information at the time of displaying of the information indicating the operation status.

According to the present embodiment, a user such as a serviceman or a manager can recognize an error which will occur in the future and prevent occurrence of the error.

### Third Embodiment

A third embodiment will be described below. In the second embodiment, the method of notifying of an error which will occur in the future in advance from an operation status and performing preventive maintenance has been described. In the example illustrated in FIG. 8, an error which will occur in the future can be checked from an operation status of a component. However, it cannot be ascertained that an error having occurred already has occurred because contamination indicated by the operation status has been left. When it can be seen that the cause of the occurring error is based on the operation status, it is possible to facilitate a user's identifying a cause and a sorting operation necessary for recovery of the error.

Therefore, in the present embodiment, it is assumed that information indicating that an error displayed on an error check screen occurs because a state indicated by an operation status has been left is displayed on a screen. In the following description, the same constituents as in the first and second embodiments will be referred to by the same reference signs, and description thereof will be omitted.

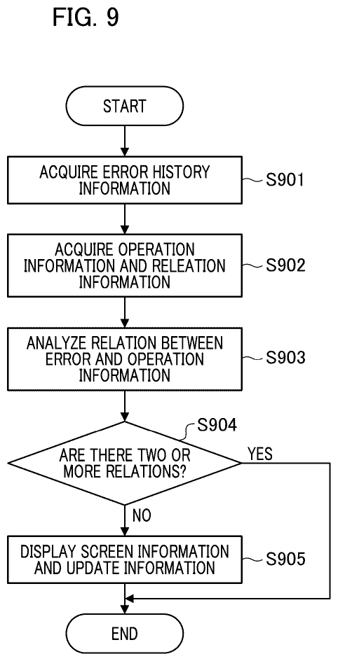

FIG. 9 is a flowchart illustrating a process flow of generating an error screen that is performed by the device management server 101 according to the present embodiment. The flowchart illustrated in FIG. 9 is started by the repair sequence display unit 317 with reception of an error screen acquisition request from the browser 331 of the information terminal 103 via the operation information receiving unit 311 as a trigger. First, in S901, when an error screen acquisition request is received, the repair sequence display unit 317 acquires error history information from the error history managing unit 313.

In S902, the repair sequence display unit 317 acquires an operation status from the operation status managing unit 701. The acquired information indicates the operation status associated with an error occurring currently acquired in S901.

In S903, a relation between the operation status acquired in S902 by the repair sequence display unit 317 and the error history information is analyzed. Specifically, information such as an occurrence date and time and a device ID from the error history information and information such as a counter value, a state value, a state value update date and time, and a device ID from the operation status are compared. By performing the comparison, an error occurrence date and time is predicted in consideration of a rate of increase of the counter value from the state value update date and time. It is analyzed that there is a relation when the prediction result is a value close to an actual error occurrence date and time.

In S904, it is determined whether there are a plurality of relations determined in S903. When there are a plurality of relations, it is considered that there are a plurality of causes of occurrence of an error, and thus display according to the present embodiment is not performed. When there is a single cause of occurrence of an error, the corresponding operation status is considered to be the cause, and thus data such as HTML for displaying screen information in S905 is generated and returned to the browser 331. A result indicating that the corresponding operation status is the cause is stored in the operation status managing unit 701.

When it is determined in S904 that there are a plurality of factors, it is not displayed, but the present invention is not limited thereto and all occurrence factors serving as the cause. In consideration of an occurrence frequency or the like, only special factors may be displayed. The repair sequence display unit 317 analyzes a relation between the operation status and the error-related information in S903, and the operation status managing unit 701 may analyze the relation.

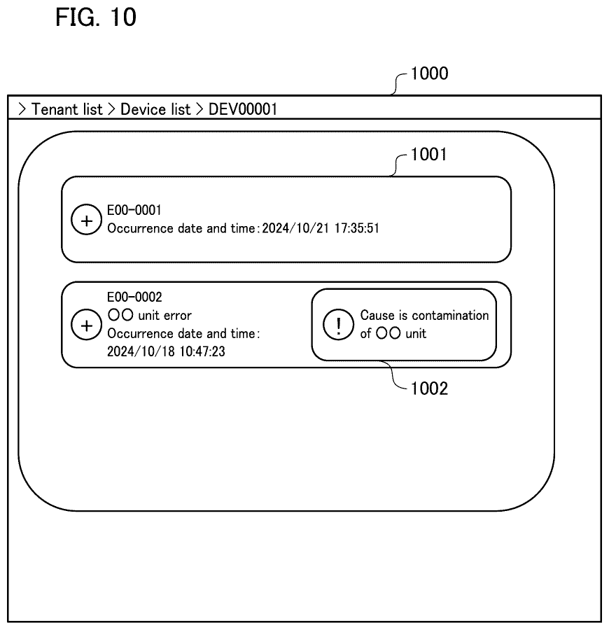

FIG. 10 illustrates an example of an error display screen displayed by the browser 331 on the basis of data returned in S905. An error display screen 1000 includes information on an error designated via the browser 331. Reference sign 1001 indicates error information which occurs currently in the image forming apparatus 102. Reference sign 1002 indicates information correlated with an error (a predicted error) which will occur in the future in S904. Information indicating a cause of the error is displayed in Reference sign 1002. That is, the information terminal 103 displays information indicating the correlated operation status in correlation at the time of display of the error information.

According to the present embodiment, a user such as a serviceman and a manager can recognize an error occurring because an operation status has been left and increase a maintenance priority of the corresponding error.

### Fourth Embodiment

A fourth embodiment will be described below. In the third embodiment, the method of notifying of an error which has occurred because measures have not been taken in response to notification of an operation status has been described. In the image forming apparatus 102, when there is no relation between an error and an operation status (such as a degree of contamination) of each component, there is a likelihood that display of the degree of contamination or the like will not be cleared even if the error or the like has been resolved. In this case, an asynchronous state in which display of the degree of contamination remains in the image forming apparatus 102 even when the error has been resolved in the device management server 101 and the operation status (such as the degree of contamination) has been improved occurs.

Therefore, in the present embodiment, an example in which an operation status correlated with and error and an operation status in the image forming apparatus 102 are changed to a resolved state when a resolved error is an error having occurred because the operation status (such as the degree of contamination) has been left will be described. In the following description, the same constituents as in the first to third embodiments will be referred to by the same reference signs, and description thereof will be omitted.

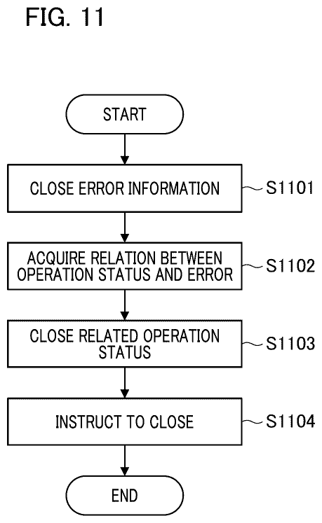

FIG. 11 is a flowchart illustrating a process flow of causing the device management server 101 to check a resolution status of an error and to update an operation status in the image forming apparatus 102 according to the present embodiment. This flowchart is mainly started by the operation status managing unit 701. In S1101, the device management server 101 performs a process of closing resolved error information. The process of closing error information may be a closing operation (not illustrated) from a user via the browser 331 or may be performed in response to an error resolution event received from the image forming apparatus 102. That is, the operation status managing unit 701 also updates information on the related operation status when the error corresponding to the error information has been resolved.

In S1102, an analysis result associated with a relation between the operation status and the error information acquired in S903 of FIG. 9 is received. For example, the relation information is obtained by preparing information in which the operation status and the error information are correlated as shown in Table 10 when the analysis result indicates there is a relation.

In S1103, the operation status managing unit 701 acquires operation information correlated with the error closed in S1101.

In S1104, the image forming apparatus 102 is instructed to close the same operation status as a closing object on the basis of the information acquired in S1102. That is, an instruction to update information indicating the operation status is transmitted to the object device. This transmission can be performed, for example, from the network I/F 257. That is, the network I/F 257 serves as an instruction means for instructing an object device to update information indicating the operation status. On the basis of this instruction, the image forming apparatus 102 closes a target operation status and synchronizes the device management server 101 with the image forming apparatus 102. This instruction may be acquired by polling from the image forming apparatus 102 as long as an instruction can be transmitted from the device management server 101 to the image forming apparatus 102.

According to the present embodiment, a user such as a serviceman and a manager can perform a maintenance job without repeatedly processing resolved notification.

### OTHER EMBODIMENTS

Embodiments of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025-012057, filed Jan. 28, 2025, which is hereby incorporated by reference wherein in its entirety.

What is claimed is:

1. A management system comprising an object device and a management device that manages an operation status of the object device,
wherein the object device includes:
a memory storing instructions; and
a processor executing the stored instructions causing the object device to transmit operation information including error information in the object device and information indicating an operation status of components of the object device to the management device,
wherein the management device includes:
one or more memories storing instructions; and
one or more processors executing the stored instructions causing the management device to:
acquire the operation information including error information in the object device and information indicating the operation status of components of the object device from the object device,
manage the acquired operation information, and
provide the managed operation information to a display device, and
wherein the error information and the information indicating the operation status are displayed on the display device on the basis of the provided operation information.

2. The management system according to claim 1, wherein the information indicating the operation status includes condition information that is calculated by the object device using an inference algorithm prepared for the components of the object device on the basis of sensor values detected by sensors corresponding to the components, and
wherein the condition information is provided as a part of the operation information to the display device such that the condition information is displayed.

3. The management system according to claim 1, wherein the execution of the stored instructions by the one or more processors further causes the management device to correlate the error information with the information indicating the operation status, and
wherein the error information and the information indicating the operation status which are correlated are displayed on the display device.

4. The management system according to claim 3, wherein the error information includes a first date and time at which an error has occurred, and the information indicating the operation status includes a state value corresponding to the operation status and a second date and time at which updating with the state value has been performed, and
wherein the correlation is performed when a time difference between the second date and time and the first date and time is less than a predetermined period and the state value is equal to or greater than a predetermined value.

5. The management system according to claim 3, wherein execution of the stored instructions by the one or more processors further cause the management device to:
predict an error which is to occur in the future from a predetermined operation status on the basis of the correlation between the error information and the information indicating the operation status; and
provide prediction information which is the prediction result along with the operation information, and
wherein the prediction information is displayed on the display device at the time of displaying of the information indicating the operation status.

6. The management system according to claim 3, wherein execution of the stored instructions by the one or more processors further causes the management device to:
update the information on the related operation status when an error corresponding to the error information has been resolved; and
instruct the object device to update the information indicating the operation status.

7. The management system according to claim 1, wherein the information indicating the operation status includes a value detected by a sensor provided in each component of the object device.

8. The management system according to claim 7, wherein a mark based on the value detected by the sensor is displayed on the display device as the information indicating the operation status.

9. An information management method for a management system including an object device and a management device that manages an operation status of the object device, the method comprising:
transmitting operation information including error information in the object device and information indicating an operation status of components of the object device from the object device to the management device;
causing the management device to acquire the operation information including error information in the object device and information indicating the operation status of components of the object device; and
providing the operation information managed in the management device to a display device,
wherein the error information and the information indicating the operation status are displayed on the display device on the basis of the provided operation information.
